(19) United States
(12) Patent Application Publication
(10) Pub. No.: US 2008/0075019 A1
(43) Pub. Date: Mar. 27, 2008

(54) Data Mapping and Sorting Method in Network Communication

(76) Inventor: Charles E. Petras, Pullman, WA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/863,152

(22) Filed: Sep. 27, 2007

Related U.S. Application Data
(60) Provisional application No. 60/847,559, filed on Sep. 27, 2006.

(51) Int. Cl. H04L 12/28

(52) U.S. Cl. 370/254

(57) ABSTRACT

Provided is a flexible data mapping method for both asynchronous and synchronous data network communications in which output data frames of variable data sizes may be mapped from input data frames of variable data sizes without limiting synchronizing data frames using time slots or fixed data size. The method generally comprises the steps of transmitting data in the form of a plurality of data frames to an IED; receiving at least one of the data frames using the IED, wherein each of the input data frames includes at least one data slot associated therewith; sorting each of the input data frames according to either a time stamp, a receipt time or a combination thereof; mapping output data slots to form respective output data frames from respective the input data slots using a mapping table stored in the IED; and transmitting the respective output data frames to one or more respective IEDs.

### CROSS-REFERENCE TO RELATED APPLICATIONS

This application claims benefit under 35 U.S.C. §119(e) of U.S. Provisional Application Ser. No. 60/847,559, entitled “A Data Mapping and Sorting Method in Network Communication,” filed Sep. 27, 2006, naming Charles E. Petras as the inventor, the complete disclosure thereof being incorporated herein by reference.

### BACKGROUND OF THE INVENTION

The present invention relates to a method for mapping data for both an asynchronous and a synchronous data network. More specifically, a method for mapping data is provided wherein output data frames of variable data sizes may be mapped from input data frames of variable data sizes. A sorting method is further provided for data mapping involving time stamped and non-time stamped data.

Network communication systems face ever-growing challenges in data transport speed and capacity. One of the challenges in network communication is the ability to individually extract a respective data size (data slot) within a corresponding data frame from a plurality of data inputs. Another challenge is forming a plurality of respective outputs wherein each output is a data frame carrying respective selected data slots from respective input frames.

Another challenge involves the ability to distinguish between various different messaging protocols in a network.

It is an object of the present invention to provide a flexible data mapping method for both asynchronous and synchronous data network communications.

It is another object of the invention to provide a flexible data mapping method in which output data frames of variable data sizes may be mapped from input data frames of variable data sizes without limiting synchronizing data frames using time slots or fixed data size.

It is yet another object of the present invention to provide a method for sorting various messages which comprise time stamped and non-time stamped data.

These and other desired benefits of the preferred embodiments, including combinations of features thereof, of the invention will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the multiple embodiments of the invention, not necessarily the invention in general.

### SUMMARY OF THE INVENTION

Provided is a flexible data mapping method for both asynchronous and synchronous data network communications. The flexible data mapping method is adapted such that output data frames of variable data sizes may be mapped from input data frames of variable data sizes without limiting synchronizing data frames using time slots or fixed data size. Further provided is a method for sorting various messages which comprise time stamped and non-time stamped data.

More specifically, a device is provided for mapping data among intelligent electronic devices (IEDs) in a network communication environment, wherein data is communicated among the IEDs in the form of data frames having at least one data slot associated therewith. The device generally comprises a memory location including a mapping table including instructions for mapping data among the IEDs, a communications channel for receiving at least one of the data frames, and a microprocessor adapted to sort each of the received data frames according to either a time stamp, a receipt time or a combination thereof. The microprocessor is further adapted to map output data slots to form respective output data frames from respective received data slots using the mapping table stored in the IED.

A method of mapping data among IEDs in a network communication environment is further provided in yet another embodiment of the present invention. The IEDs according to this system are adapted to communicate the data in the form of data frames. The method generally comprises the steps of transmitting data in the form of a plurality of input data frames to an IED; receiving at least one of the input data frames using the IED, wherein each of the input data frames includes at least one input data slot associated therewith; sorting each of the input data frames according to either a time stamp, a receipt time or a combination thereof; mapping output data slots to form respective output data frames from respective input data slots using a mapping table stored in the IED; and transmitting the respective output data frames to one or more respective IEDs.

In another embodiment of the present invention, another method of mapping data among IEDs in a network communication environment is provided wherein the IEDs are adapted to communicate the data in the form of data frames having time stamped data associated therewith. The method generally comprises the steps of transmitting data in the form of a plurality of input data frames to an IED; receiving at least one of the input data frames, wherein each of the input data frames includes at least one input data slot associated therewith; correlating a measured arrival time of a first received input data frame; initiating a time interval from the measured arrival time wherein subsequent input data frames are to be received; receiving the input data frames during the time interval; sorting the input data frames received within the time interval based on time stamp data; determining whether the input data slots are unavailable or missing; mapping output data slots to form respective output data frames from the respective sorted input data slots using a mapping table stored in the IED; and transmitting the respective output data frames to another IED.

In yet another embodiment, provided is another method of mapping data among IEDs in a network communication environment, wherein the IEDs are adapted to communicate the data in the form of data frames. The method generally includes the steps of transmitting data in the form of a plurality of input data frames to an IED; receiving at least one of the input data frames, wherein each of the input data frames includes at least one input data slot associated therewith; correlating a measured arrival time of a first received input data frame; initiating a time interval from the measured arrival time wherein subsequent input data frames are to be received; receiving input data frames during the time interval; sorting the input data frames received within the time interval; determining whether the input data slots are unavailable or missing; mapping output data slots to form respective output data frames from the respective sorted input data slots using a mapping table stored in the IED; and transmitting the respective output data frames to another IED.

In another embodiment, another method is provided for mapping data among IEDs in a network communication environment, wherein the IEDs are adapted to communicate the data in the form of data frames and some of the data frames have time-stamped data associated therewith. The method generally includes the steps of transmitting data in the form of a plurality of input data frames to an IED; receiving at least one of the input data frames, wherein each of the input data frames includes at least one input data slot associated therewith; correlating a measured arrival time of a first received input data frame; initiating a time interval from the measured arrival time wherein subsequent input data frames are to be received; using a sorting by time stamp data method upon receipt of the first input data frame with a time stamp before the expiration of the time interval; using a sorting by measured arrival time method upon expiration of the time interval without detection of time stamp in the first input data frame; determining whether the input data slots are unavailable or missing; mapping output data slots to form respective output data frames from respective sorted input data slots using a mapping table stored in the IED; and transmitting the respective output data frames to another IED.

It should be understood that the present invention includes a number of different aspects or features which may have utility alone and/or in combination with other aspects or features. Accordingly, this summary is not exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a diagram of a system for mapping data among a plurality of IED's within a communication network system in accordance with an aspect of the present invention.

FIG. 2A illustrates an example of a data frame which may be mapped using the present invention system and method.

FIG. 2B illustrates another example of a data frame which may be mapped using the present invention system and method.

FIG. 2C illustrates yet another example of a data frame which may be mapped using the present invention system and method.

FIG. 3A is a diagram of a system for mapping data among a plurality of IEDs in accordance with an embodiment of the present invention.

FIG. 3B illustrates an example of a mapping table which may be used in conjunction with the system of FIG. 3A.

FIG. 4A is a diagram of a graphical user interface (GUI) or a human machine interface (HMI) for implementing an embodiment of the present invention.

FIG. 4B illustrates an example of a mapping table based on the configuration shown in FIG. 4A in accordance with an aspect of the present invention.

FIG. 5A is a diagram of a device or system for mapping a plurality of output data frames based on the order in which a plurality of respective non-time stamped input data frames are received in accordance with an aspect of the present invention.

FIG. 5B is a diagram of a data mapping method with time stamped input data to outputs.

FIG. 5C is a diagram of another device or system for mapping a plurality of mixed mode data frames wherein there is a combination of time stamped and non-time stamped or invalid time stamped input data frames in accordance with an aspect of the present invention.

FIG. 6 depicts a mixed mode data sorting table, wherein input frames of different time stamps and synchronization status from a plurality of IEDs are presented to a mapping IED in many arrival sequences in accordance with an aspect of the present invention.

FIG. 7 depicts a data mapping method in network communication in accordance with another aspect of the present invention.

### DETAILED DESCRIPTION OF THE INVENTION

The present invention is directed to a method for mapping data is provided wherein output data frames of variable data sizes may be mapped from input data frames of variable data sizes. Although the various embodiments describe a system and apparatus associated with a network device in an electric power system, it is contemplated that the present invention system and apparatus may be used with a device associated with any type of computer network. Suitable computer networks may include local area networks (LANs), wide area networks (WANs) or any other computer networks which include a plurality of network devices which send messages therebetween using various protocols.

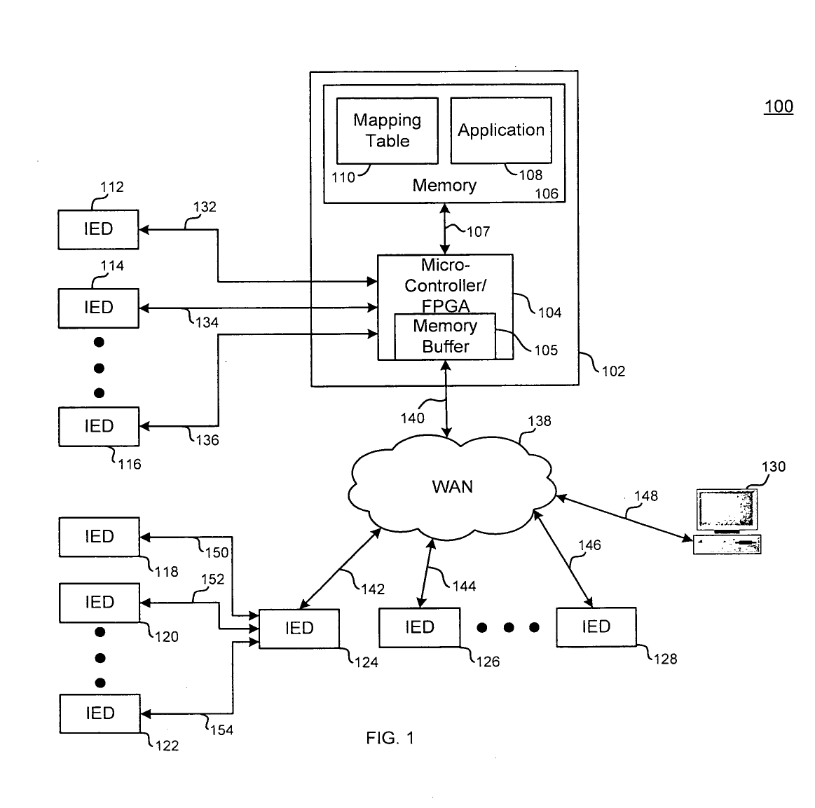

FIG. 1 illustrates an embodiment of a system for mapping data among a plurality of intelligent electronic devices (IED's) within a communication network system 100 in accordance with an aspect of the present invention. IEDs 102, and 112 to 130 may be in the form of a Synchrophasor Processor, Phasor Data Concentrator (PDC), Phasor Measurement Unit (PMU), Synchrophasor, protective relay, a computing device, a personal digital assistant (PDA), a handheld communication device such as a Blackberry cell phone etc. etc. For example, in one embodiment of the present invention, IEDs 102, and 124 to 128 of FIG. 1 may be in the form of PDCs whereas IEDs 112 to 122 of FIG. 1 may be in the form of PMUs. Furthermore, IED 130 may be a server to monitor, map, archive and display mapped data on a web based application or to perform automation, control and protective function in the power system.

In the embodiment illustrated in FIG. 1, IED 102 may be considered a target IED. IED 102 includes memory 106 such as a FLASH, RAM or FPGA in which a mapping table 110 may be stored. Memory 106 may further include an application 108 which includes instructions for processing the mapping table. IED 102 further includes a microcontroller or an FPGA 104 with a memory buffer 105 which may be adapted to process the mapping and data sorting functions as specified by the mapping table 110 and application 108. Accordingly, the micro-controller 104 may map data without using a central control switch found in a TDMA network.

Data may be communicated among IEDs 112 to 130 via a wide area network (WAN) and target IED 102 through multiple I/O addresses (not shown). The data may be communicated to the target IED in the form of a plurality of input frames carrying data slots from corresponding plurality of source IEDs 112 to 130.

In another embodiment, data may be mapped in successions in one or more IEDs. For example, IED 124 may be adapted to map data from IEDs 118 to 122 and communicate through links 150 to 154 with mapped data to the rest of the IEDs through Ethernet communication link 142 and the WAN 138.

In another embodiment, IEDs 112 to 116 may communicate with IED 102 through bidirectional serial communication links 132 to 136. IEDs 118 to 130 may communicate with IED 102 through a Wide Area Network (WAN) 138 using Ethernet communication links 140 to 148. In yet another embodiment, the WAN 138 may be adapted to support the IEC 61850 communication protocol for fast communication messages among IEDs of different manufacturers within the network. Yet in another embodiment, the communication links between IEDs may be encrypted and secured through known encryption methods.

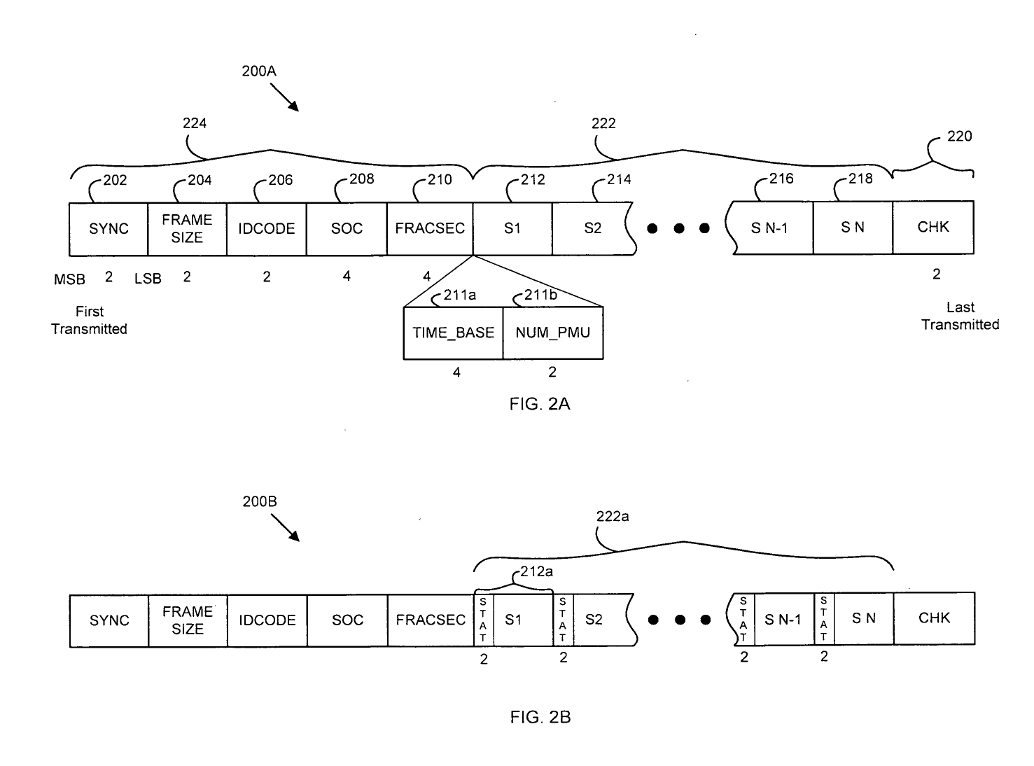

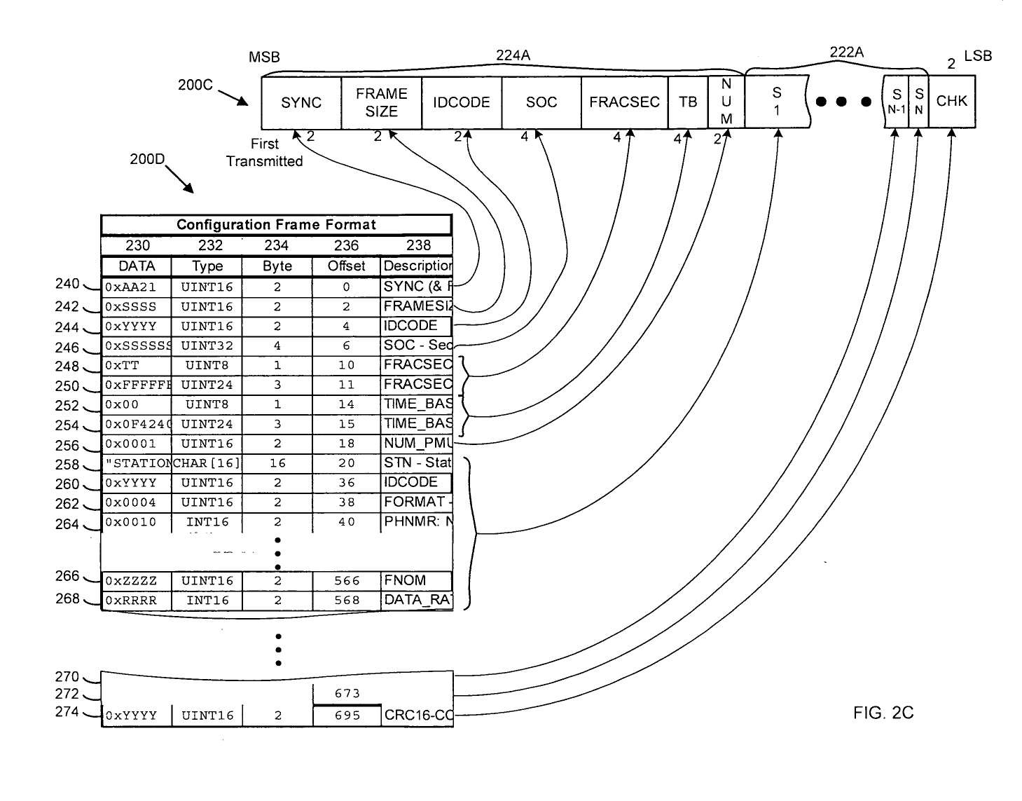

As described with respect to FIG. 1, the present invention provides a method for mapping one or more output data frames (herein after output frames), wherein each output frame comprises a payload composed of one or more slots and wherein each slot is mapped from one or more input data frames/slots. An example of such an output data frame is illustrated in FIG. 2A.

FIG. 2A illustrates an example of a data frame 200A which may be mapped using the present invention system and method. The data frame 200A generally complies with the generic transmission sequence defined by IEEE Standard C37.118 for power systems. IEEE Standard for Synchrophasors for Power Systems: IEEE Std C37.118™-2005 is incorporated by reference herein and made a part hereof. This transmission sequence is generally used for communication among phasor measurement units (PMUs). The data frame 200A generally includes a header 224, a payload 222 and a CHK (check sum) 220. SOC 208 is a second of century representation typically referenced to some standard source (i.e., for the system shown in FIG. 1, all the IEDs would use the same time source standard). FRACSEC 210 represents a fraction of second encoded per TIME_BASE 211a.

The header 224 generally includes the sequence as shown in FIG. 2A. SYNC 202 (2 bytes) represents a synchronization word first transmitted in the frame 200A. SYNC 202 may also specify whether the frame being transmitted is a configuration frame or a data frame. FRAME SIZE 204 (2 bytes) specifies the total number of bytes (generally, 65535 bytes max) in the data frame 200A including CHK. IDCODE 206 (2 bytes) specifies an identifying code. For example, IDCODE may be a number assigned by a user (generally, between 1 to 65534) which identifies the device sending and receiving messages.

The data frame 200A may generally be a configuration frame or a non-configuration frame. If the data frame 200A is a configuration frame, the header 224 includes a TIME_BASE slot 211a and a NUM_PMU slot 211b. The TIME_BASE slot 211a defines the time stamp. The NUM_PMU 211b slot defines the number PMUs included in the data frame 200A. If the data frame 200A is a non-configuration data frame, the slots TIME_BASE 211a and NUM_PMU 211b are absent in the header 224.

The payload 222 may comprise a plurality of slots S1 212 to SN 218, wherein each slot is a select size. The slots S1 212 to SN 218 may be the same or may vary in size. If the frame 200A is a configuration data frame, each of the slots S1 212 to SN 218 in the payload 222 will be a configuration slot for each PMU. The configuration data frame is sent once. The configuration data frame also precedes the input data frames regardless of an earlier time stamp status from input data frames on the network. If there is a data configuration change in any PMU, a new configuration data frame will be sent again before any other PMU data frame arrives.

If the frame 200A is a non-configuration data frame, each of the slots S1 212 to SN 218 in the payload 222 will include a preceding STAT word indicating the data configuration and synchronization status in the slot. The minimum byte size for any slot in the payload may be selected at two bytes. Therefore, an empty slot in the payload will have the STAT word only without data. The CHK 220 is a check sum, CRC-CCITT (cyclic redundancy check code as described in Annex B of IEEE Std C37.118-2005) last transmitted to complete data frame.

FIG. 2B illustrates an example of a data frame 200B which may be mapped using the present invention system and method. The data frame 200B generally complies with the generic transmission sequence defined by IEEE Standard C37.118 for power systems. More specifically, FIG. 2B shows a data frame 200B, wherein the payload 222a has a plurality of slots S1 to SN. Each slot has a “STAT” word 212a (generally 2 bytes) preceding any data in the slot. If bit 13 of the “STAT” word is set to “0” and the SOC and FRACSEC slots in the header 224B have a valid time stamp (within tolerance of the reference time in the system), the data frame is time stamped. Otherwise, the frame 222B is not time-stamped.

Yet in another embodiment, an input or output data frame may include a pre-configured word preceding the data in the slot (not shown in FIG. 2B) showing a priority in processing the data frame without waiting for the completion of data frames from the rest of source IEDs or PMUs. Such a pre-configured word in the slot may initiate a priority action to the mapping IED or target IED. For example a pre-configured word may initiate a protective function, emergency alarm or any action to call for immediate attention to the source IED system or target IED system within the network.

FIG. 2C illustrates an example of a data frame 200C which may be mapped in accordance with a configuration frame format table 200D. The data frame 200C generally complies with the generic transmission sequence defined by IEEE Standard C37.118 for power systems. Rows 240 to 274 indicate the content of the slots of the configuration data frame 200C. Columns 230 to 238 categorize the frame structure. Column 230 specifies the configuration word (row), generally in the form of a hexadecimal. Column 232 specifies the data type. Column 234 specifies the byte size of each word. Column 236 specifies the offset or cumulative byte size of the data frame 200C. Column 238 specifies the description of the word.

Rows 240 to 256 are generic words mapped to the respective slots in the header 224A of data frame 200C. Rows 252 and 254 represents TIME_BASE, which is mapped to slots TB defining resolution of fraction-of-second time stamp. Row 256 represents NUM_PMU, which is mapped to slot NUM defining the number of PMUs included in the data frame. Rows 258 to 268 defines a configuration of a PMU mapped to slot 1 in the payload 222A. As illustrated, slots S1 to SN may have varying byte sizes. Row 258 represents STN, defining station name. Row 260 represents IDCODE, which defines the PMU ID number and identifies source of each data block. Row 262 represents FORMAT, which defines the data format within the data frame. Row 264 represents PHNMR, which defines a number of phasors. Row 266 represents FNOM, which defines the nominal line frequency code and flags. Row 268 represents DATA_RATE, which defines the rate of transmission. Rows 270 to 272 are new configuration slots SN−1 and SN for new PMUs, where the contents are variants of slot 1. Row 274 is CRC16-CCITT, which is mapped to the last slot CHK for parity check sum of the data frame 200C.

Other field configurations that may be used for the data frame 200C are defined in the IEEE Standard for Synchrophasors for Power Systems: IEEE STD C37.118™-2005.

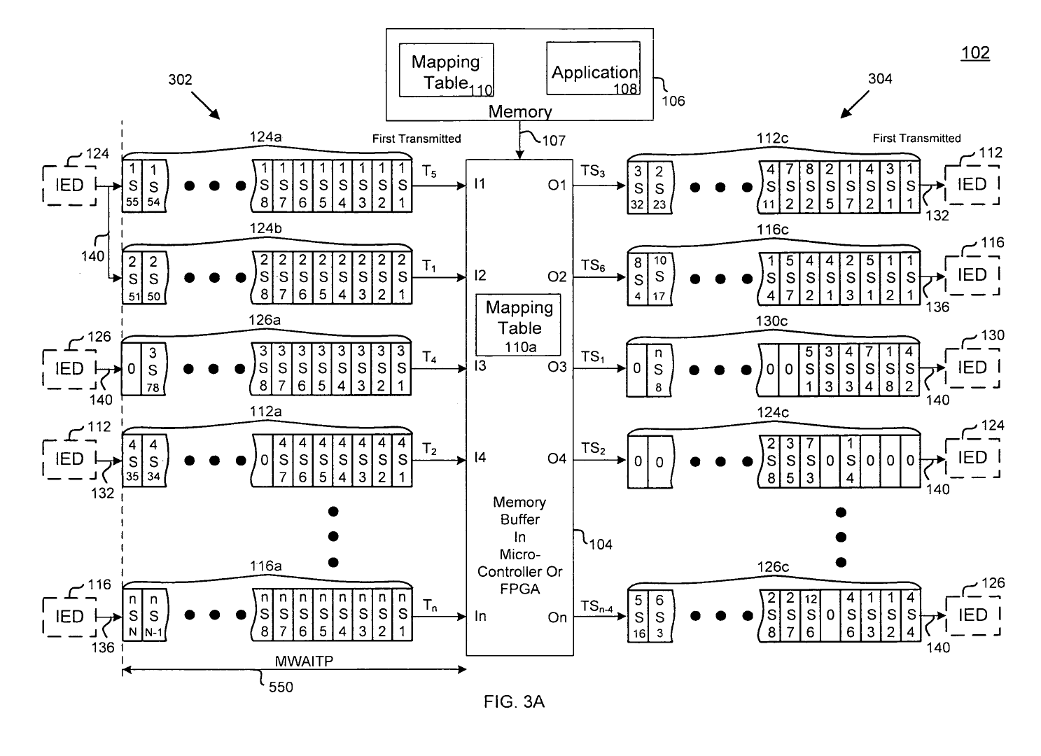

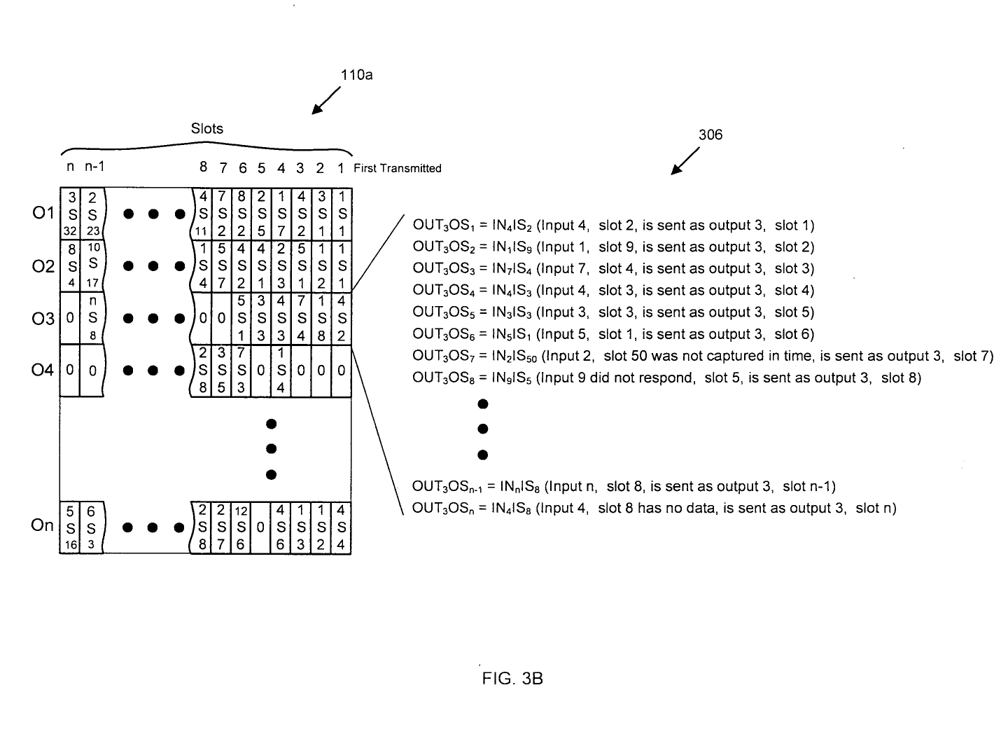

FIG. 3A illustrates a system for mapping data among a plurality of IEDs in accordance with an embodiment of the present invention. The system of FIG. 3A is generally adapted to communicate data in the form data frames. The data frames may be in the form of data frames 200A-200C as described in FIGS. 2A-2C or other data frames.

FIG. 3A, more specifically, describes a system or device 102 which maps data frames from a plurality of IEDs to a plurality of target IEDs. The system or device 102 receives input data frames 112a, 116a, 124a, 124b and 126a from a plurality of source IEDs 112, 116, 124 and 126. The system or device 102 processes these input data frames to form output data frames 112c, 116c, 124c, 126c and 130c which are mapped to corresponding target IEDs 112, 116, 124, 126 and 130 in accordance with the mapping table 110 and the processing instructions of the application 108.

More specifically, IEDs 112, 116, 124 and 126 transmit data in the form of data frames to IED 102 in the form of input data frames 112a, 116a, 125a, 124b and 126b. IED 102 receives the input data frames via the buffer of the micro-controller/FPGA 104. Accordingly, although the plurality of input data frames 112a, 116a, 124a, 124b and 126a are transmitted to the IED 102 at various time ranges from T1 to Tn, the input data frames are read into a buffer of micro-controller (or read into a FPGA) 104 within a wait period (MWAITP) 550.

In one embodiment, the MWAITP 550 is a measured wait period starting at the detection of a first valid time stamp slot such as slot 2S1 of data frame 124b from IED 124 arriving at the micro-controller at T1 (earliest arrival). The micro-controller 104 waits for a defined time interval of MWAITP 550 and then cuts off to read all the successfully received data frames in the buffer. In other words, a successfully received data frame is one having the CHK slot read in time by the buffer within the current wait period MWAITP 550 to be considered successfully received.

The formed respective output data frames 112c, 116c, 124c, 126c and 130c are generated according to a mapping table 110 and the instructions provided by application 108. The mapping table 110 maps the input slots from the buffer and populates the output slots. Slots with zeros indicate that the slot is empty, or there were missing or unavailable slots in the previously received mapped data frames. Generally, if the zero filled slot contains a status indicator or word, then that status will be set such that it indicates that this slot contains unreliable data if that is indicated by something other than zero.

As shown in this embodiment, the IEDs may also be adapted to transmit successive input data frames. For example, IED 124 is shown to transmit successive input data frames 124b and 124a that are read at time T1 and T5 by the buffer in micro-controller 104.

FIG. 3B illustrates an example of a mapping table which may be used in conjunction with the system or device of FIG. 3A. The output data frames are generally composed of slots mapped from the input data frames. In configuring the mapping table 110a, a plurality of statements such as statements 306 are used to link the respective output slots S1 to Sn from input slots of various inputs.

For example, for a system with n inputs (where each input contains multiple data slots in its payload), output frame 3 could be constructed in the Mapping Table 110a thus:

OUT₃OS₁ = IN₄IS₂ (Input 4, slot 2, is sent as output 3, slot 1)
OUT₃OS₂ = IN₁IS₉ (Input 1, slot 9, is sent as output 3, slot 2)
OUT₃OS₃ = IN₇IS₄ (Input 7, slot 4, is sent as output 3, slot 3)
OUT₃OS₄ = IN₄IS₃ (Input 4, slot 3, is sent as output 3, slot 4)
OUT₃OS₅ = IN₃IS₃ (Input 3, slot 3, is sent as output 3, slot 5)
OUT₃OS₆ = IN₅IS₁ (Input 5, slot 1 is sent as output 3, slot 6)
OUT₃OS₇ = IN₂IS₅₀ (Input 2, slot 50 was not captured in time, is sent as
output 3, slot 7)
OUT₃OS₈ = IN₉IS₅ (Input 9 did not respond, slot 5, is sent as output 3,
slot 8)
OUT₃OSₙ₋₁ = INₙIS₈ (Input n, slot 8, is sent as output 3, slot n − 1)
OUT₃OSₙ = IN₄IS₈ (Input 4, slot 8 has no data, is sent as output 3, slot n)

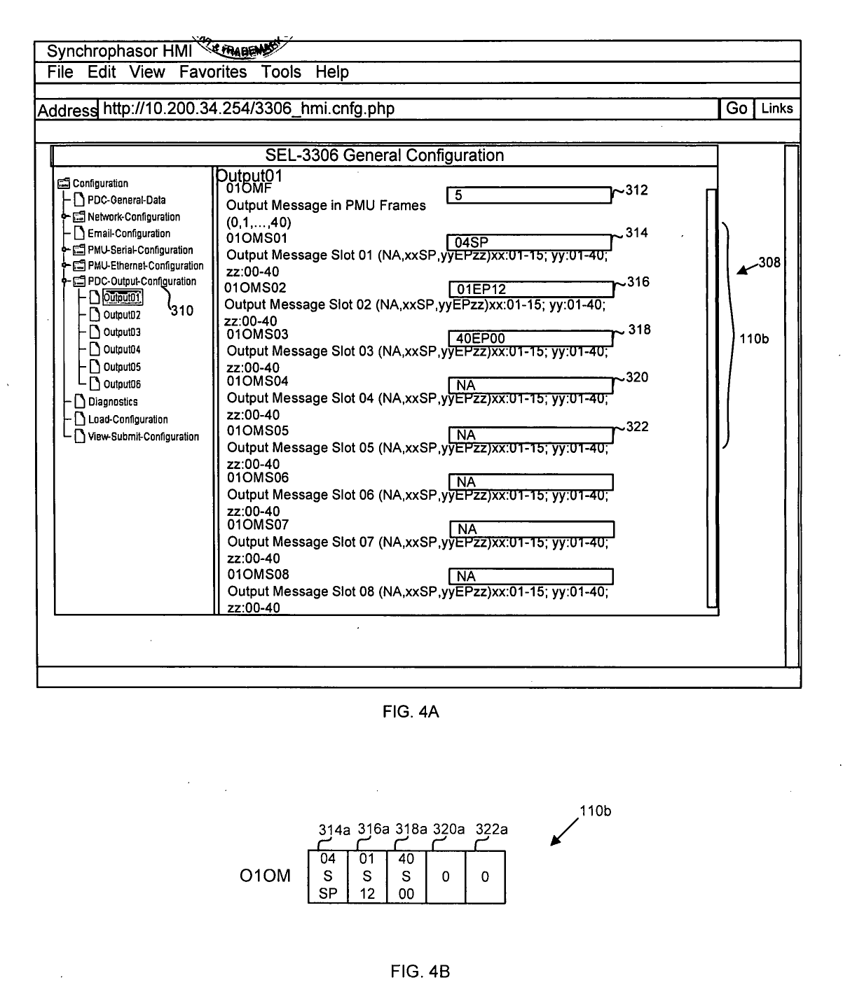

FIG. 4A illustrates a graphical user interface (GUI) or a human machine interface (HMI) for implementing an embodiment of the present invention having an IED output data configuration frame format from a plurality of inputs. The GUI or HMI 308 may be implemented in an IED having mapping capabilities such as a phasor data concentrator (PDC). An example of a PDC is the SEL 3306 Synchrophasor processor manufactured by Schweitzer Engineering Laboratories, Inc.

In this embodiment, the PDC comprises six available outputs 310 with IED inputs up to PMU1 to PMU40. Output 1 data frame 312 is configured with five slots. The first output slot 01OMS01 is mapped to 04SP 314 (serial input port 4). Since serial communication has a typical 56 Kbps, the serial input data frame usually has a single data slot. Thus, 04SP 314 specifies the only data slot available is serial port 4. The second output slot 010MS02 is mapped to 01EP12 (Ethernet input port 1, slot 12) 316. The third output slot 01OMS03 is mapped to 40EP00 (Ethernet input port 40, slot 0) 318. The fourth output slot 01OMS04 320 and fifth output slot 01OMS05 322 are both unmapped to any input. In an embodiment, the PDC may have up to 40 inputs with a single data slot (such as a serial input) from each input frame or a single input frame with up to 40 slots. The GUI or HMI may further be a software tool that runs an application 108, such as that illustrated in FIG. 1 and within well-established web browser platforms such as a Windows Internet Explorer®.

FIG. 4B illustrates an example of a mapping table based on the configuration shown in FIG. 4A in accordance with an aspect of the present invention. FIG. 4B is a mapping table 110b for output 1. The content of output slots 314a to 322a may generally constructed from the graphical user interface input configurations in FIG. 4A.

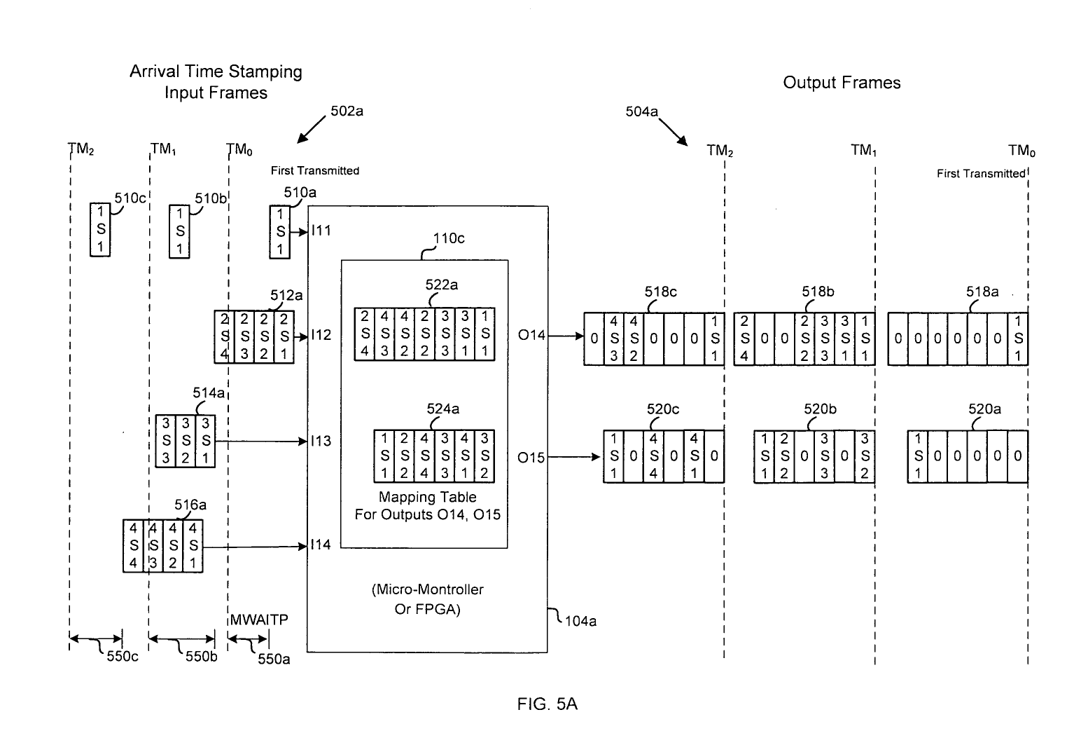

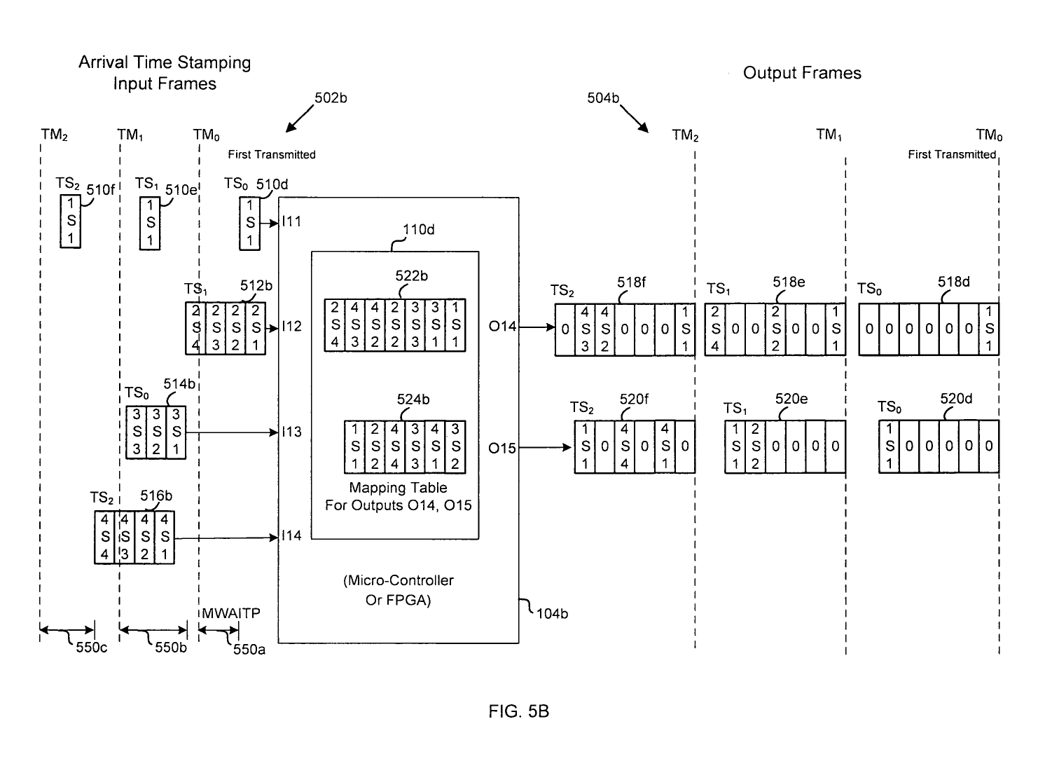

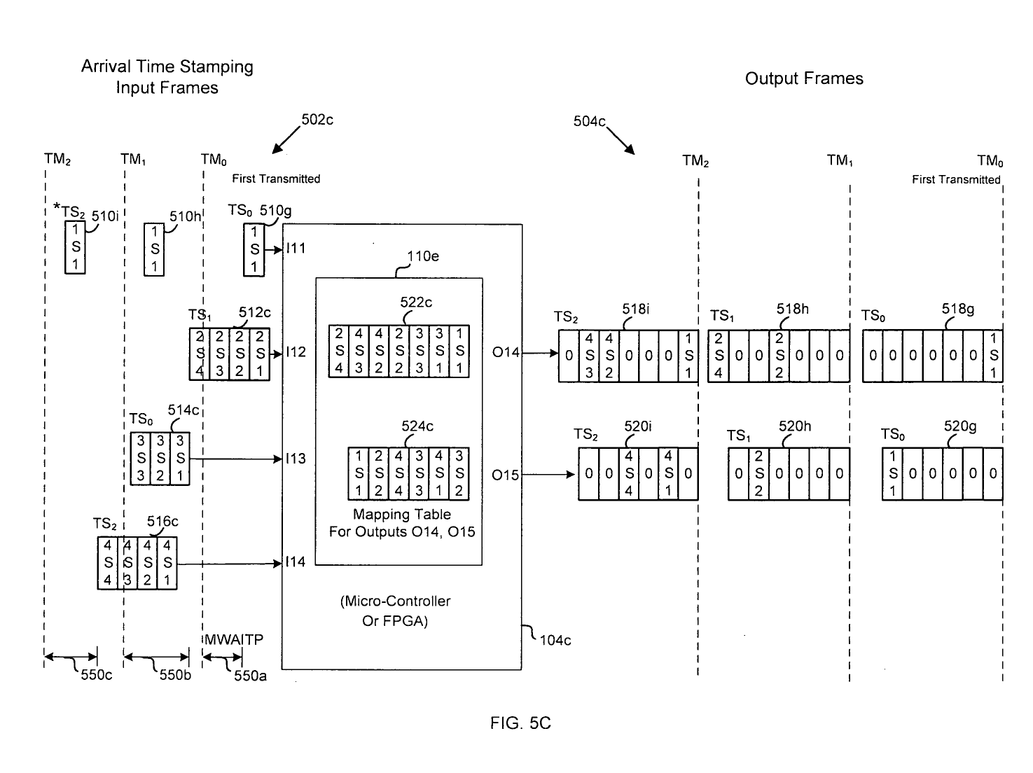

FIG. 5A depicts a device or system for mapping a plurality of output data frames based on the order in which a plurality of respective non-time stamped input data frames are received in accordance with an aspect of the present invention. The device or system of this embodiment maps non-time stamped input data to outputs 014 and 015. In accordance with input data having a generic transmission sequence defined by IEEE Standard C37.118 for power systems, non-time stamped input data frames generally refer to data frames where the STAT slot (first data slot) is not set to “TRUE”, or the time stamp value of the data frame is outside the range of the reference time in the system at the time of input data frame arrival.

In FIG. 5A, input 111 is a serial input wherein each input data frame is composed of a single data slot. Inputs 112 to 114 are Ethernet inputs wherein each input data frame 512a to 516a is composed of at least one data slot. A mapping table 110c in the micro-controller or FPGA 104a maps input data frames 510a to 510c, 512a, 514a and 516a from 111 to 114 to form respective output data frames 522a and 524a for outputs 014 and 015. Wait periods MWAITP 550a to 550c are used to validate completion of arriving data within the time intervals.

For the TM0 output data frame, input data frame 510a is the only data frame read by micro-controller 104a within the MWAITP 550a wait period. Input data frame 512a has not completed transmission within the MWAITP 550a wait period and, is therefore, considered as not being received within the MWAITP 550b wait period. The mapped data for outputs 518a and 520a include slots (1S1) from frame 510a only.

For the TM1 output data frame, the received input data frames are frames 510b, 512a and 514a. Therefore, mapped data for outputs 518b and 520b include slots from input data frames 510b, 512a and 514a.

For the TM2 output data frame, the received input data frames are frames 510c and 516a. The mapped data for outputs 518c and 520c include slots from both frames 510c and 516a.

FIG. 5B depicts another device or system for mapping a plurality of output data frames based on the order in which a plurality of respective time stamped input data frames are received in accordance with an aspect of the present invention.

FIG. 5B illustrates an embodiment of data mapping method with time stamped input data to outputs 014 and 015. In accordance with input data having a generic transmission sequence defined by IEEE Standard C37.118 for power systems, time stamped input data frames generally refer to data frames where the STAT slot (first data slot) is set to “TRUE” and the time stamp value of the data frame is within the range of the reference time in the system at the time of input data frame arrival. For output data frame comparison purpose, the slots of the input data frames 510d to 510f, 512b, 514b and 516b are the same as those in FIG. 5A except with time stamping TS0 to TS2; and the mapping table 110d is the same as 110c.

For the TM0 output data frame, input data frame 510d with time stamp TS0 is the only data frame read by micro-controller 104b within MWAITP 550a wait period. Input data frame 512b with time stamp TS1 has not completed transmission within the MWAITP 550a wait period and, therefore, no corresponding input data is received. The mapped TS0 data frame for outputs 518d and 520d include slot (1S1) from input data frame 510d only.

For the TM1 output data frame, the received input data frames are frames 510e with time stamp TS1, 512b with time stamp TS1 and 514b with time stamp TS0. Input data frame 514b with time stamp TS0 is discarded since it is received after the expiration of MWAITP 550a wait period. Therefore, mapped data for outputs 518e and 520e include slots from input frames 510e and 512b.

For the TM2 output data frame, the received input data frames are frames 510f and 516b with time stamp TS2. The mapped data for outputs 518f and 520f include slots from both input frames 510f and 516b.

FIG. 5C depicts another device or system for mapping a plurality of mixed mode data frames wherein there is a combination of time stamped and non-time stamped or invalid time stamped input data frames in accordance with an aspect of the present invention.

For output data frame comparison purpose, the slots of the input data frames 510g to 510i, 512c, 514c and 516c are the same as those in FIGS. 5A and 5B except with time stamping and non-time stamping data to input I11; and the mapping table 110e is the same as 110c and 110d.

For the TM0 output data frame, input data frame 510g with time stamp TS0 is the only data frame read by micro-controller 104b within MWAITP 550a wait period. Input data frame 512c with time stamp TS1 has not completed transmission within the MWAITP 550a wait period and, therefore, no corresponding input data is received. The mapped TS0 data for outputs 518g and 520g include slot (1S1) from frame 510g only, same as in FIGS. 5A and 5B.

For the TM1 output data frame, the received input data frames are frames 510h without time stamp, 512c with time stamp TS1, and 514b with time stamp TS0. Non-time stamped input data frame 510h is discarded since a sorting by time stamp method is invoked when a first time stamped input data 512c with time stamp TS1 is first detected and started the MWAITP 550b waiting period. Input data frame 514b with time stamp TS0 is discarded since it is received after the expiration of the MWAITP 550a waiting period. Therefore, mapped data for outputs 518h and 520h include slots from input data frame 512c only.

For the TM2 output data frame, the received input data frames are input data frame 510i with an invalid time stamp TS2 and input data frame 516c with a time stamp TS2. Although input data frame 510i has a STAT slot set to “TRUE” for time stamping, the FRACSEC or the SOC slots in the header are outside the range of time reference in the mapping IED within the network system. Another example can be the data frame 510i is sent with a local time stamp while the mapping IED in the network uses absolute time reference thus showing an invalid time stamp. Accordingly, in both instances, the mapped data for outputs 518i and 520i include slots from frame 516c only.

In an embodiment, the missing or unarrived slots in output data frames 518a to 518i, 520a to 520i in FIGS. 5A to 5C are filled with zeros or otherwise a word to indicate absence of data from the respective IEDs.

Yet in another embodiment, the late arrived missing data or non-time stamped data can be archived separately for later retrieval.

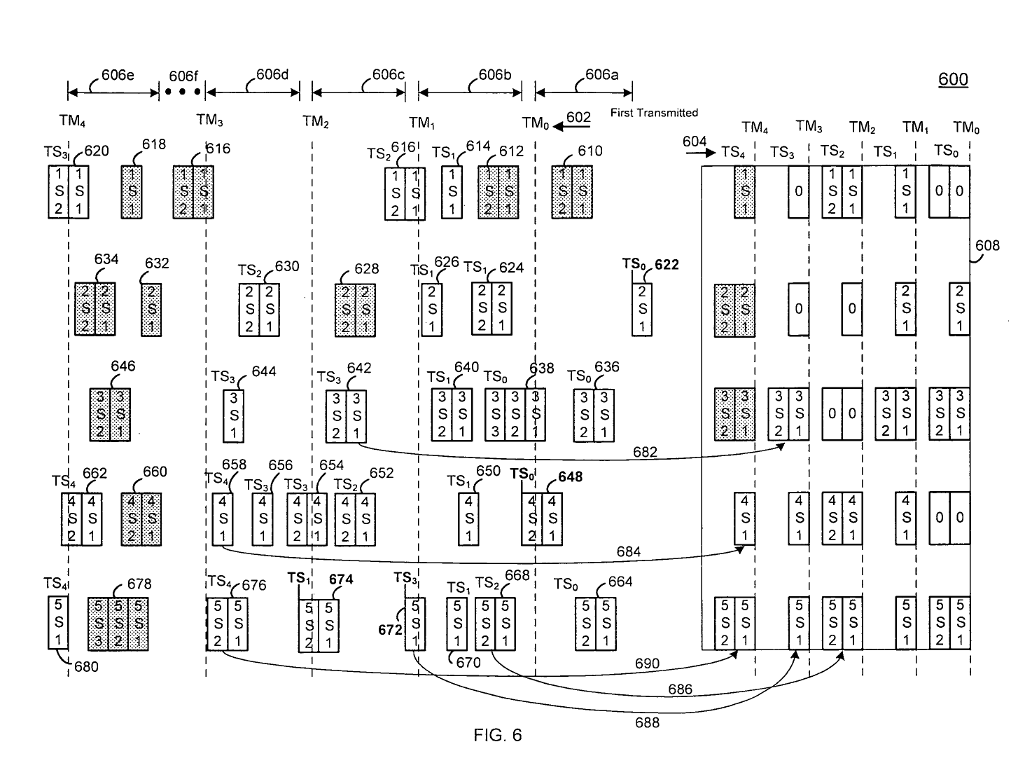

FIG. 6 depicts a mixed mode data sorting table, wherein input frames of different time stamps and synchronization status from a plurality of IEDs are presented to a mapping IED in many arrival sequences in accordance with an aspect of the present invention.

In FIG. 6, a plurality of mixed mode input frames are depicted as slots without showing header and checksum slots for simplification purposes only. Slots 610 to 680 of different time stamps TS0 to TS4 and synchronization status (slots shown with or without time stamp) from a plurality of activated source IEDs such as PMU1 to PMU5 (not shown) are presented to a mapping IED 600 such as a synchrophasor processor or a PDC according to arrival time sequences 602 (TM0 to TM4) within the respective measured wait periods (MWAITP) 606a to 606e. FIG. 6 further illustrates two methods for sorting input data frames—“sort by time stamp” and “sort by arrival”.

For the “sort by time stamp” method, each of the MWAIT 606a to 606d starts upon the detection of a first valid time stamp slot such as slot 622 for TM0, slot 648 for TM1, slot 672 for TM2, slot 674 for TM3. Upon expiration of a defined time interval such as from one to five seconds etc., the MWAIT cuts off to read data to the buffer 608 from input slots within the respective MWAITP 606a to 606e. All slots from non-time stamped frames within this MWAITP are ignored or discarded. In an embodiment, the ignored slots may be filled with zeros in the buffer 608. In another embodiment, the ignored slots may contain a word to reflect missing data, wherein the missing data can be stored at an archive buffer at later periods for retrieval.

The time interval 606f between TM3 and TM4 is a defined time interval such as between one to five seconds etc. in instances where there is no detection of any time stamped frame. After this time interval, another MWAIT 606e begins under measured received time TM4. During this interval, a “sort by arrival” or “sort by receipt” method begins for all non-time stamped slots and continues until detection of a time stamped slot such as slot 662. Detection of a time stamped slot restarts the “sort by time stamp” method and the respective MWAIT period.

In another example illustrated by FIG. 6, both time stamped and non-time stamped input slots 610 to 680 are read by the buffer 608 using time stamp 604 or received time 602 sequences. In some instances, duplicated slots such as 636 and 638 of time stamp TS0 are received at different arrival times TM0 and TM1. In other instances, slots 624 and 626 of time stamp TS1 are received at the same arrival time TM1.

At arrival time TM0, slot 622 from source PMU 2 is the first slot detected with a time stamp TS0. This initiates the MWAITP 606a and “sort by time stamp” method for the data slots of PMU1 to PMU5 in MWAITP 606a. Since slot 610 of PMU1 has no time stamp, the data in this slot is discarded and replaced with zeros in the buffer 608. Similarly, slots 636 and 664 of PMU3 and PMU5 are time stamped TS0 and read by buffer 608. Slot 648 of PMU4 arrives after the expiration of MWAITP 606a, and is therefore considered missing data in the TM0 arrival time frame. Accordingly, slot 648 is discarded and replaced with zeros in buffer 608.

Regarding arrival time TM1, slot 648 from source PMU 4 is the first slot detected with a time stamp TS0. This initiates the MWAITP period 606b and continues the “sort by time stamp” method. Although slot 648 has TS0 time stamp, the slot arrives after the expiration of MWAITP 606a and is therefore discarded. In an embodiment, slot 648 is a received after MWAITP 606a and will therefore be archived to an archive buffer (not shown) for later retrieval. Slot 650 with time stamp TS1 from PMU4 arrives within the MWAITP period 606b and is thus read by buffer 608. Slots 612 (non-time stamped) and slot 614 with TS1 time stamp are both from PMU1, slot 612 (non-time stamped) will be discarded and slot 614 will be read by buffer 608. Since slots 624 and 626 of PMU2 are both duplicative data with time stamp TS1, the more current slot 626 is read by buffer 608 and the earlier slot 624 is discarded or archived. Slot 638 of PMU3 with time stamp TS0 will be discarded or archived due to arrival after the expiration of MWAITP 606a. Slot 640 of PMU3 with time stamp TS1 is read by buffer 608. Slot 668 with time stamp TS2 of PMU5 arrives ahead of its schedule and ahead of slot 670 (time stamp TS1) and is considered valid and read by buffer 608 in TM2 logical space through bypass 686. Slot 670 with time stamp TS1 is read by buffer 608 within the arrival time TM1.

Yet in another embodiment not shown, in a situation where a slot with TS1 time stamp arrives after a slot with TS2 time stamp, the “sort by time stamp” method will read the data frame with a newer time stamp and terminate the wait period. In this way, any data frame with earlier time stamp is processed. For example, the data in slot 668 with newer time stamp TS2 of PMU5 will be read by buffer 608 while the data in slots 624, 626, 640, 650 with time stamp TS1 will be read by buffer 608, but the data in slot 670 with TS1 will be discarded. In a situation where a slot with TS1 time stamp arrives earlier than a slot with TS2 time frame; the slots of both TS1 and TS2 will be read by buffer 608 and the wait period will expire. A new time stamped data frame will start another new wait period cycle. This embodiment will allow faster real-time processing of most up to date input data frame, but at an expense of losing the out of order data.

Regarding arrival time TM2, slot 672 from source PMU 5 is the first slot detected with a time stamp TS3, thereby initiating MWAITP 606c and the “sort by time stamp” method. Similarly, the early arrived slot 672 having a time stamp TS3 is considered valid and read by buffer 608 in TM3 logical space through bypass 688. Slot 616 of PMU1 with time stamp TS2 is read by buffer 608. Slot 628 of PMU2 is non-time stamped and therefore discarded. Slot 642 of time stamp TS3 of PMU3 arrives early and is read by buffer 608 through bypass 682. Time stamp TS2 data for PMU3 is missing, therefore buffer 608 fills the missing data with zeros. Slot 652 of PMU4 with time stamp TS2 is read by buffer 608.

Regarding arrival time TM3, slot 674 from source PMU 5 is the first slot detected with a time stamp TS1, thereby initiating MWAITP 606d and the “sort by time stamp” method. Slot 674 with time stamp TS1 arrives after TM1 expired and is therefore discarded or archived. Time stamp TS3 data for PMU1 is missing, therefore buffer 608 fills the missing data with zeros. Slot 630 with time stamp data TS2 arrives after TM2 expires and is therefore discarded or archived. Time stamp TS3 data for PMU2 is missing, therefore buffer 608 fills the missing data with zeros. Slot 644 of PMU3 with time stamp TS3 is read by buffer 608. Slots 654 and 646 of PMU4 are both duplicative data with time stamp TS3; the more current slot 656 is read by buffer 608 and the earlier slot 654 is discarded or archived. Slot 658 with time stamp TS4 arrives early and is read by buffer 608 in TM4 logical space through bypass 684. Similarly, slot 676 of PMU 5 with time stamp TS4 arrives early and is read by buffer 608 in TM4 logical space through bypass 684.

After MWAITP 606d, for a defined time interval 606f after MWAITP, no time stamped slot including slot 616 of PMU1 is detected. In an embodiment, the micro-controller of mapping IED 600 invokes a “sort by arrival” method and starts a wait period 606e under measured arrival time TM4 at measured rate (MRATE) to sort incoming non-time stamped slots such as 618, 632, 634, 646, 660 and 678 etc. More specifically, under the “sort by arrival” or “sort by receipt” method, slot 618 of PMU1, slot 634 of PMU2 supersedes slot 632, slot 646 of PMU3, slot 660 of PMU4 and slot 678 of PMU5 etc. are all valid data and are therefore read by buffer 608 in the TM4 logical space. However, buffer 608 already includes valid time stamped data for PMU4 and PMU5 from the earlier MWAITP 606d. Accordingly, the respective non-time stamped slots 660 and 678 will be discarded. Also, the data in the TM4 logical space for PMU1 to PMU5 will be sent or mapped to the output frames under the same time stamp of TS4 by virtue of the time stamped slots of PMU4 and PMU5. The “sort by arrival” method will continue to sort non-time stamped slots with subsequent repeating wait periods 606e until slot 662 of PMU4 with time stamp TS4 is first detected; therefore restarting the “sort by time stamp” method and the respective MWAITP.

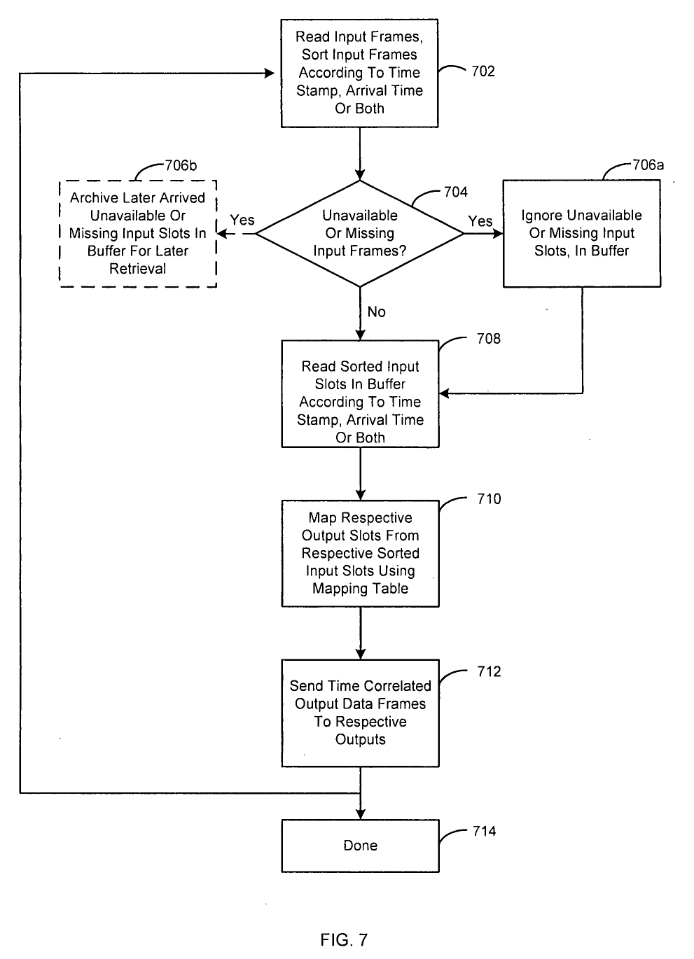

FIG. 7 depicts a data mapping method in network communication in accordance with another aspect of the present invention. The method generally includes the following steps:

Step 702: Read Input Frames, Sort Input Slots According To Time Stamp, Arrival Or Both;

Step 704: Check for unavailable or missing input frames. If there are no unavailable or missing frames, proceed to step 708 to read sorted input slots in buffer according to time stamp, arrival time or both. If there are unavailable or missing frames, proceed to step 706a to ignore unavailable or missing slots, or, alternatively, to step 706b, to archive later arrived unavailable or missing input slots in buffer for later retrieval.

If, however, there are no missing or unavailable input frames, the method proceeds from step 708 (described above) to step 710: Map respective output slots from respective sorted input slots using mapping table; and step 712: Send time correlated output data frames to respective outputs. The method then repeats with step 702 as input frames are received. Alternatively, the method ends in step 714.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

What is claimed is:

1. A method of mapping data among intelligent electronic devices (IEDs) in a network communication environment, said IEDs adapted to communicate the data in the form of data frames, the method comprising the steps of:
transmitting data in the form of a plurality of input data frames to an IED;
receiving at least one of the input data frames using the IED, wherein each of the input data frames includes at least one input data slot associated therewith;
sorting each of the input data frames according to either a time stamp, a receipt time or a combination thereof;
mapping output data slots to form respective output data frames from respective input data slots using a mapping table stored in the IED; and
transmitting the respective output data frames to one or more respective IEDs.

2. The method of claim 1 further comprising the step of determining whether input data slots are unavailable or missing.

3. The method of claim 2, further comprising the step of filling output data slots with zeros for unavailable or missing respective input data slots.

4. The method of claim 2, further comprising the step of providing a word indicator in an output data slot for a corresponding unavailable or missing input data slot.

5. The method of claim 2, further comprising the step of archiving late arrived, unavailable, or missing input data slots in memory for later retrieval.

6. The method of claim 1, wherein the data is communicated using a protocol selected from a group consisting of serial, Ethernet, IEC 61850 standard, MODBUS and DNP.

7. The method of claim 1, wherein at least one of the input or output data frames conforms to the IEEE C37.118 standard.

8. The method of claim 1, wherein at least one of the input or output data frames is synchronous, asynchronous or a combination thereof.

9. The method of claim 1, wherein at least one of the input or output data frames is time stamped, non-time stamped or a combination thereof.

10. The method of claim 1, wherein at least one of the input or output data frames is time correlated according to a measured receipt time.

11. The method of claim 1, wherein the mapping table is configurable through HMI or GUI inputs to the IED.

12. The method of claim 1, wherein the IED is a power system device selected from the group consisting of a Phase Data Concentrator, an I/O processor, a Synchrophasor Processor, a protective relay, a host computer, a Personal Digital Assistant device (PDA), a handheld communication device, and a handheld computer.

13. A method of mapping data among intelligent electronic devices (IEDs) in a network communication environment, said IEDs adapted to communicate the data in the form of data frames having time stamped data associated therewith, comprising the steps of:
transmitting data in the form of a plurality of input data frames to an IED;
receiving at least one of the input data frames, wherein each of the input data frames includes at least one input data slot associated therewith;
correlating a measured arrival time of a first received input data frame;
initiating a time interval from the measured arrival time wherein subsequent input data frames are to be received;
receiving the input data frames during the time interval;
sorting the input data frames received within the time interval based on time stamp data;
determining whether the input data slots are unavailable or missing;
mapping output data slots to form respective output data frames from the respective sorted input data slots using a mapping table stored in the IED; and
transmitting the respective output data frames to another IED.

14. A method of mapping data among intelligent electronic devices (IEDs) in a network communication environment, said IEDs adapted to communicate the data in the form of data frames, comprising the steps of:
transmitting data in the form of a plurality of input data frames to an IED;
receiving at least one of the input data frames, wherein each of the input data frames includes at least one input data slot associated therewith;
correlating a measured arrival time of a first received input data frame;
initiating a time interval from the measured arrival time wherein subsequent input data frames are to be received;
receiving input data frames during the time interval;
sorting the input data frames received within the time interval;
determining whether the input data slots are unavailable or missing;
mapping output data slots to form respective output data frames from the respective sorted input data slots using a mapping table stored in the IED; and
transmitting the respective output data frames to another IED.

15. A method of mapping data among intelligent electronic devices (IEDs) in a network communication environment, said IEDs adapted to communicate the data in the form of data frames, some of the data frames having time-stamped data associated therewith, comprising the steps of:
transmitting data in the form of a plurality of input data frames to an IED;
receiving at least one of the input data frames, wherein each of the input data frames includes at least one input data slot associated therewith;
correlating a measured arrival time of a first received input data frame;
initiating a time interval from the measured arrival time wherein subsequent input data frames are to be received;
using a sorting by time stamp data method upon receipt of the first input data frame with a time stamp before the expiration of the time interval;
using a sorting by measured arrival time method upon expiration of the time interval without detection of time stamp in the first input data frame;
determining whether the input data slots are unavailable or missing;
mapping output data slots to form respective output data frames from respective sorted input data slots using a mapping table stored in the IED; and
transmitting the respective output data frames to another IED.

16. The method of 15, wherein the sorting by time stamp data method further comprises the steps of:
correlating a measured arrival time of the first received input data frame;
initiating a time interval from the measured arrival time wherein subsequent input data frames are to be received;
receiving input data frames during the time interval; and
sorting the input data frames received within the time interval based on time stamp data.

17. The method of 15, wherein the sorting by measured arrival time method further comprises the steps of:
correlating a measured arrival time of the first input data frame;
initiating a time interval from the measured arrival time wherein subsequent input data frames are to be received;
receiving input data frames during the time interval; and
sorting the input data frames received within the time interval.

18. The method of 15, wherein input data frame with older time stamp data or late receipt is ignored or archived into a buffer within the time interval.

19. A device for mapping data among intelligent electronic devices (IEDs) in a network communication environment, said data being communicated among the IEDs in the form of data frames having at least one data slot associated therewith, the device comprising:
a memory location including a mapping table including instructions for mapping data among the IEDs,
a communications channel for receiving at least one of the data frames, and
a microprocessor adapted to sort each of the received data frames according to either a time stamp, a receipt time or a combination thereof, said microprocessor further adapted to map output data slots to form respective output data frames from respective received data slots using the mapping table stored in the IED.

20. The device of claim 19 wherein the memory location further includes an application including instructions for processing the data frames.

21. The device of claim 19 further comprising another communications channel for transmitting the output data frames to another IED.

22. The device of claim 19 wherein the communications channel is adapted to transmit the output data frames to another IED.
